(19) United States
(12) Patent Application Publication
(10) Pub. No.: US 2009/0146813 A1
(43) Pub. Date: Jun. 11, 2009

(54) Automobile forgotten passenger alarm and notification

(75) Inventor: Gustavo Nuno, Murrieta, CA (US)

Correspondence Address: Warren Coon, 16521 Corte Paulina, Poway, CA, 92064, US

(73) Assignee: Acropolis Engineering, Temecula, CA (US)

(21) Appl. No.: 12/231,294

(22) Filed: Aug. 29, 2008

Related U.S. Application Data
(60) Provisional application No. 61/005,974, filed on Dec. 10, 2007.

(51) Int. Cl. G08B 13/14; G08B 23/00

(52) U.S. Cl. 340/572.1; 340/573.1

(57) ABSTRACT

A system for installation onto automobiles that will detect forgotten or abandoned passengers and notify the driver by email, cell phone, car alarm, or other means and will allow relief or rescue of trapped passengers.

### CROSS REFERENCE TO RELATED APPLICATIONS

This application claims the benefit of Provisional Application 61/005,074, filed Dec. 10, 2007.

### FIELD OF THE INVENTION

The present invention relates to the safety of passengers (occupants) who may be left in parked automobiles while the driver or operator is away from the parking site.

### BACKGROUND OF THE INVENTION

Each year, many human or animal passengers are unintentionally left in parked cars when the driver leaves. Perhaps the driver forgets or is distracted from what was intended to be a momentary errand that can turn into an extended absence with tragic results for the occupants left behind. The inside temperature of a parked car, even if left in the shade may quickly climb to dangerous levels due to heat absorption from outside hot ambient air or radiation or from sources within the car such as the occupants themselves or equipment in the car. Human occupants who are too old, too young, or otherwise incapable of taking action to escape, or animals such as pet dogs or cats may be put in danger of injury or death by being locked in a parked car.

Conversely, danger to occupants may also derive from the excess cold if passengers are abandoned in cold or winter conditions.

The technology is already well known to remotely notify car owners of theft of their cars, as is the technology to automatically notify emergency first responders of car accidents, such as when the air bag is deployed. U.S. Pat. No. 6,028,506 by Xiao describes a car alarm transmitting system that will page the owner if his car alarm is activated. U.S. Pat. No. 7,068,153 by Flick describes a remote transmitter operated vehicle window control system.

U.S. Pat. No. 6,853,853 by Van Wiemeersch et al describes a system of adapting a vehicle remote control to connect to Internet, cell, and satellite phone systems to allow control of car systems at long distances. A car alarm system with automatic dialer is described by Mercado in U.S. Pat. No. 6,956,467. Krasner in U.S. Pat. No. 7,289,786 and Cuddihy et al in U.S. Pat. No. 7,158,016 describe vehicles with occupant sensors that remotely notify emergency personnel by cell phone, satellite link, and landlines in combination in the event of a vehicle crash.

However, the need exists for a more targeted system that would protect the occupants of a car from being inadvertently abandoned.

### SUMMARY OF THE INVENTION

The invention is a system of detectors, operator-selected notification methods, and remedies for the inadvertent neglect or desertion of passengers in parked automobiles. The invention comprises an array of detectors used singly or in combination to detect the presence of animate passengers in the car by means of voice, heartbeat, thermal (heat) radiation, or motion, RFID, bodily gases, or other means. The driver upon departing the car may disarm the device if necessary, for example if wishing to leave the car to refuel with the passengers inside.

The default position of the arming device is armed unless deliberately overruled. The driver may select how he will be notified and who else may be notified, depending on circumstances present at the time. Notification of an unintentionally forgotten or deserted passenger takes place to an announcement destination by one or more of email, voice message to a cell phone, text message to a cell phone, voice page to a cell phone or land line phone, or public address announcement from a speaker and amplifier in or on the car.

A notification to the cell phone may include a vibrate feature, by which I mean the cell phone would be programmed to vibrate upon the receipt of the call to emphasize the urgency of the call. The email, voice messages to cell phone, text messages to cell phones, and/or voice pages to cell phone may be to multiple addresses simultaneously or sequentially. These may be accomplished with the aid of a satellite link. The user may select a GPS mode which can notify emergency responders of the exact location of the vehicle. The public address announcement or voice mail message may be selected from a menu of pre-recorded messages, including as one choice, “A child or animal is in the car and needs help!” In addition, the windows of the car may be automatically rolled down, the sunroof, if installed, may open, the air conditioning (A/C) or the ventilation fan may be turned on, and the doors unlocked.

The invention provides an electronic link via dialing apparatus and a radio transmitter capable of connecting to a landline telephone system that can in turn relay data by cell phone voice or text, PDA and other means described below to an operator and others who may be able to assist a forgotten passenger or passengers.

### BRIEF DESCRIPTION OF THE DRAWINGS

FIG. 1 is a schematic of the invention

FIG. 2 is a detail of the arming sequence

FIGS. 3A and 3B are a schematic showing how the invention is used

FIG. 4 is a detail of the preferred Notification Selector

### DEFINITION OF SOME TERMS USED IN THE SPECIFICATION AND DRAWINGS

In the specification, claims, and drawings of this invention the following terms have the indicated meanings:
Announcement destination: the intended recipient of a message
Arm: activate the system
Car or automobile: includes “truck”, “van”, “SUV” or other “vehicle” capable of carrying one or more passengers.
Call to 911: a telephone call directed to an emergency dispatcher
Cell phone message: a prerecorded message delivered to the cell phone of an operator
Disarm: temporarily disable the system partly or wholly
Email alert: a voice or text message delivered to one or more cell phones
First Responders: emergency personnel such as fire, police, EMT (Emergency Medical Technician) or public safety officers designated to assist in emergencies
GPS Location: a message sent to the operator and/or the first responders giving the exact location of the vehicle; determined by global positioning satellites.
Local notification: includes messages and remedies in proximity to the car, such as P/A announcements, horn honking, lowering windows, unlocking the car, remote start, turning on A/C and fan
Motion: a movement by an occupant in the vehicle. Excludes motion caused by external motion of the vehicle
Notification: to send a message or messages to alert the operator, passersby, or emergency responders of the presence of an occupant in need of assistance
Notification choices: optional methods of notification selected by the operator
Occupants: one or more persons or animals remaining in the vehicle when parked
Operator: the person who operates the notification system and/or the car
PA system: a public address system mounted in or on a vehicle, capable of projecting an audible voice message
Remote notification: includes messages sent to the operator and/or first responders at a distance by radio, cell phone, satellite phone, or other means, or a combination of any of these
Remote start and A/C: a device capable of starting the engine of the vehicle and turning on the air conditioning of the vehicle
RFID: a device installed in or carried on an occupant to allow the presence of an occupant to be detected by radio.
Sensor: a device to detect the presence of an occupant in the vehicle.

### DETAILED DESCRIPTION OF THE INVENTION

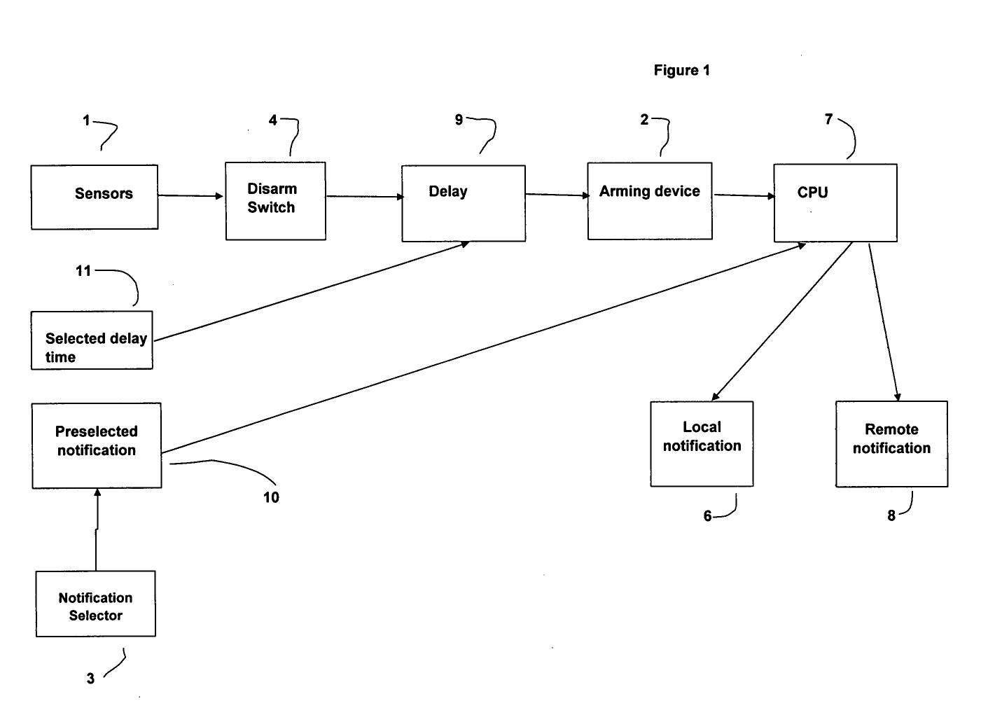

According to the invention, now referring to FIG. 1, the interior of the car is fitted with sensors 1 that can detect the presence of occupants in the car. The terms “car” and “vehicle” refer to any vehicle capable of transporting occupants on a road, trail, or highway. Sensors 1 are chosen that may detect any combination of one or more of the motion, sound, heartbeat, pulse, weight, gases such as CO2, moisture, or intestinal gas, heat given off by the occupants, or the presence of an Identification Chip or RFID 5. An animal or human occupant may have an Identification Chip or RFID 5 (not shown) inserted into the animal or a human occupant may have an Identification Chip or RFID 5 attached to his or her clothing, or worn on a bracelet, ring, or other jewelry. These sensors 1 and Identification Chips or RFIDs 5 are well known in the electronics industry and are available from electronics distributors such as Newark Electronics, Digi-key, Allied or McMasters-Carr. The signal from these detectors is fed to an arming device 2 that allows the operator to enable or not enable the detector signal to be processed. The default position of the arming device is “armed” which means the arming device is reset to “armed” each time the car is started or moved. The arming device however will not allow the detector signal to be processed, even if armed, until the car is stopped, the driver's door is opened, and the ignition key is removed. The arming device 2 may be disarmed by the driver after the car is stopped and the driver's door is opened by means of a disarm switch 4, preferably a momentary push button switch, mounted on or near the instrument panel of the car. When the car is restarted, the alarm is disarmed. The arming device 2 is in communication with the CPU 7 which routes an appropriate message to an announcement destination comprising remote notification 8 or local notification 6. CPU 7's capabilities are chosen to complement and supplement the car's existing CPU 17 (not shown) if installed.

Local notification 6 refers to devices and techniques generally known in the art for controlling features of the car by electronic commands to the car's CPU 17 (not shown.).

Many new cars have operator selected features to allow speech communication through the car's speakers (Bluetooth), control delay of lights after engine turn off, chimes and voice and visual warnings of open doors and unlock, as well as remote start and audible voice and horn warnings of break-in or attempted break-in. These features are adapted by the invention to serve as part of the forgotten passenger alarm system.

Remote notification 8 refers to devices and techniques generally well known in the art for communicating between a car and a land line or cell phone voice or data link. An example would be “On-Star™” whereby communication may be established between a car's CPU 17 (not shown) and an external data system to establish the exact GPS location of the car and to monitor performance and operation of the car, unlock the car, notify emergency personnel, and allow speech communication with the driver. The remote notification 8 comprises a dialing device to connect to a telephone line, a transmitter in the car, a receiver in the car, a radio link to a ground based system such as a cell phone tower, and land lines to a telephone exchange. The invention does not depend on the details of the remote notification 8 but uses the existing capability of the established system.

While the primary intent of the invention is to prevent deaths and injury from occupants being left in an overheated car, the invention contemplates the possibility that occupants may desirably be left in a car in cold weather, so there is optionally provided an interior car temperature sensor that disarms the alarm system when the car interior temperature is below a pre-selected temperature, for example 40 degrees F. Also, there is optionally provided an algorithm that provides rearming the system if the interior vehicle temperature falls further to a lower value, for example 30 degrees F.

Disarm switch 4 is preferably mounted together with and is part of the notification selector 3, which will be described in detail below. Disarm switch 4 allows the operator to override the alarm system for reasons appropriate to the situation as determined by the operator, such as loading additional passengers or retrieving mail from a mail box. A delay 9 is provided to allow time for the operator to have an operator selected delay time 11 sufficient to remove passengers (such as children form car seats) as desired without activating the alarm. Notification selector 3 provides the preselected notification 10 choices made by the operator to car CPU 7 so that if activated, the alarm system will perform the desired actions to alert passersby, notify the operator or emergency personnel, or remedy the forgotten passenger.

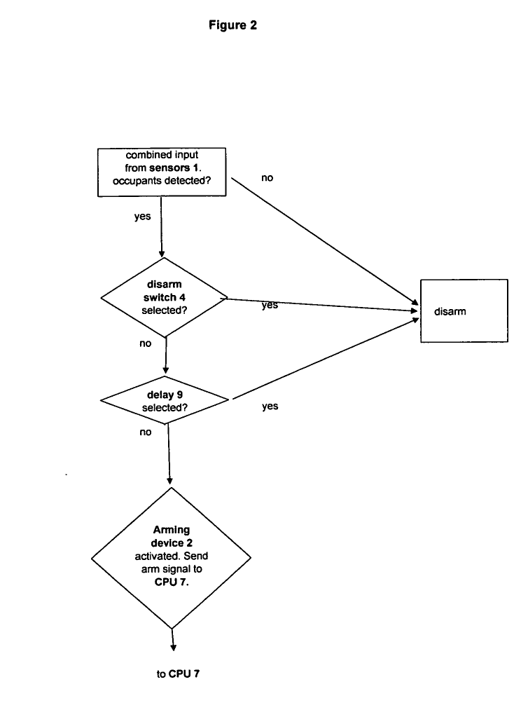

Now referring to FIG. 2, the details of the operation arming device 2 in conjunction with the sensors 1, disarm switch 4 and delay 9 are shown. The arming device 2 combines input information from sensors 1, disarm switch 4, and delay 9 to instruct the CPU 7 to execute local notification 6 or remote notification 8. Input information from sensors 1, disarm switch 4, and delay 9 are combined using well-known logic circuitry techniques and readily available logic circuits available from electronic parts houses such as Allied Electronics. If delay 9 is selected to delay (“yes” in FIG. 2) for a selected period, upon expiration of the selected period the delay will revert to “no”, and the logic circuitry will then permit the arming device 2 to be activated and an arm signal will go to the CPU 7. In the preferred embodiment, a default delay time of two minutes is suggested.

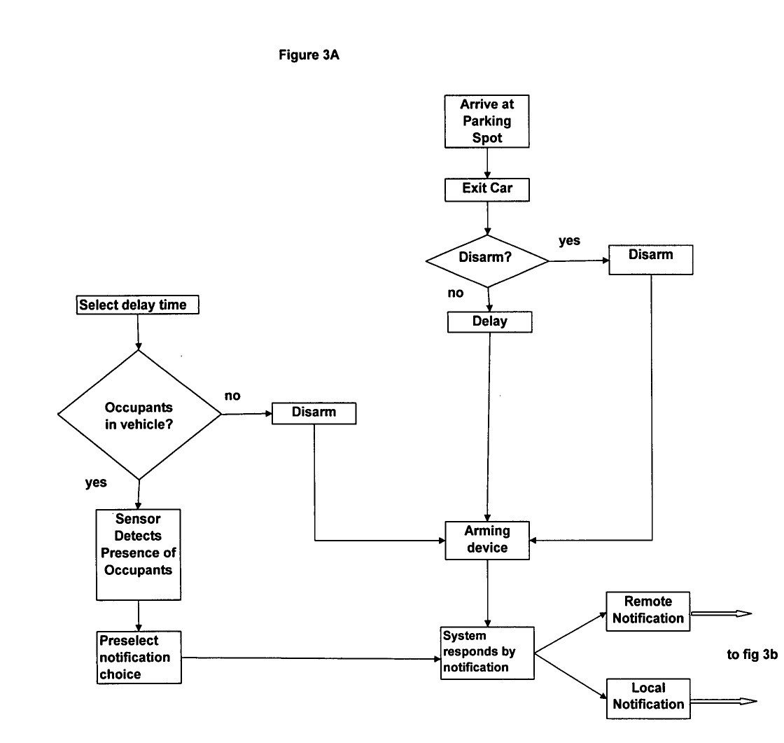

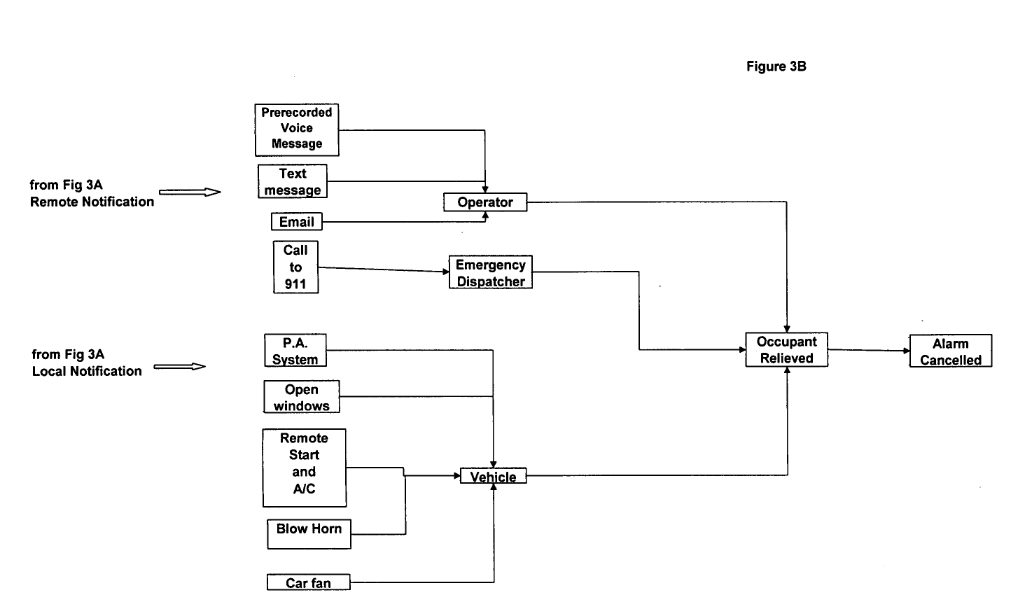

FIGS. 3A and 3B show how the invention is used. Initially the operator of the car will configure the system by programming the appropriate information into the notification selector 3. The choices of Local/Remote/Local+Remote/Disarm and notification destination are programmed directly into the notification selector as described above. In addition, such information as the desired voice message to operator, text message, appropriate emergency telephone numbers (e.g. 911) and the operator's cell, home, business and other telephone numbers and one or more email addresses, and public address announcement message would preferably be conveyed through flash memory slot 15 from a camera card 16 (not shown) containing a spreadsheet file such as Excel containing information entered previously onto the card 16 at a personal computer not shown).

Upon arrival at the destination or other stopping/parking place where the driver may exit the vehicle, the driver may elect to arm (default) or disarm the system depending on circumstances. For example, if the driver wishes to exit the vehicle to get mail or refuel he may wish to disarm the system depending on the time he expects to be gone, the temperature/weather conditions, and the safety environment. For a longer duration of exit, he may wish to have the system armed. Since the system arms by default no action is necessary on his part in this latter instance. A built in delay 9 is provided to prevent over-reaction if the driver stops, gets out, and helps passengers exit the vehicle without disarming the system. The time delay of delay 9 is selectable by the operator by pressing the delay button on notification selector 3 repeatedly.

After the system is armed, upon the above conditions being met, the presence of occupants in the vehicle is detected by one or more sensors 1 placed within the car and in communication with the CPU 7. Communication may be by wired or wireless connection techniques well known in the art. Upon the one or more sensors detecting the presence of occupants, the CPU 7 activates the announcement destination 18 (not shown) to route the message to remote notification 8 or local notification 6, or both, as pre-selected by the notification selector 3. Then, depending on the notification methods chosen, the operator or others are notified of the presence of occupants in the car and they can take appropriate action to remedy the conditions until the operator can return tot he car. In the most preferred embodiment the local notification 6 will be utilized and will include the selection of the remote start and air conditioning start, windows open, fans activate, doors unlock, and PA announcement.

In an alternate embodiment, there is also provided a warning chime or preferably a warning audio message audible in the car such as “Check for passengers in car” that is activated each time the ignition key is removed from the car ignition. This message or chime would be repeated a number of times, preferably three times, and then would cease. We contemplate that this alternative embodiment would preferably precede the other notifications of the system so that the operator could take preventive corrective action before leaving the car.

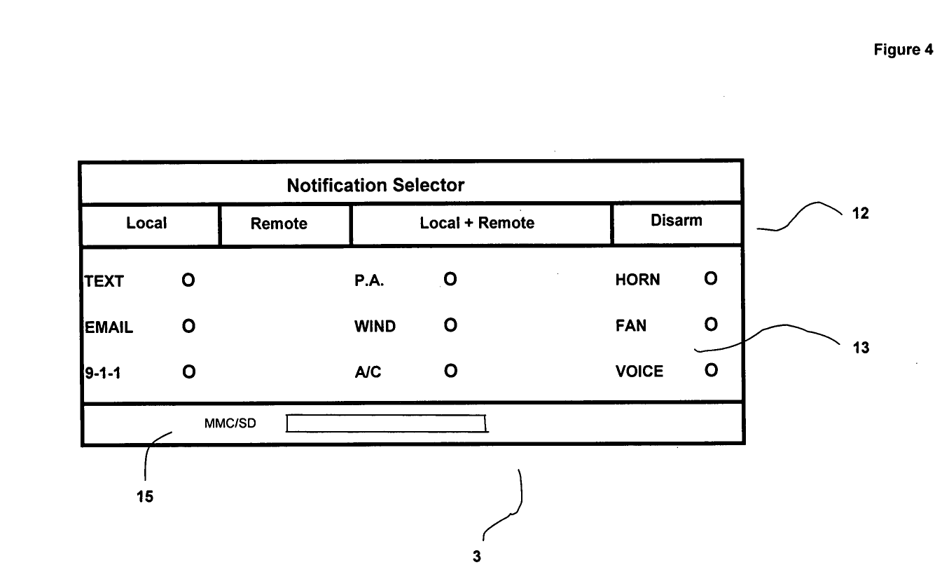

Now referring to FIG. 4 there is also preferably installed on or near the instrument panel of the car a notification selector 3 that allows the driver or operator of the car to select how the alarm notification will be passed on to those who can assist the passengers. The driver or operator may select from “local” or “remote” or both. If no choice is made, both local and remote notification is selected by default. The notification selector 3 has a row of lighted switch pads 12 that can be selected by the operator and which will light up when selected. Below this row of switch pads 12 there is an array of lighted switch pads 13 which when pressed by the operator will select the notification method from the available choices. Each chosen notification method will light up when selected to indicate that the specific choice has been selected. The choices available according to the invention preferably include at least text, email, call to emergency 911 operator, public address through a car speaker system capable of being heard from outside the car, opening the car windows, turning on the air conditioning, blowing the car's horn, turning on the fan, and sending a prerecorded voice message to the operator's cell phone. The notification selector preferably contains electronic memory 14 (not shown) accessed through a camera card flash memory slot 15, USB port, or other means, that can store a prerecorded message to be announced locally or remotely, as well as the desired selected delay time 11. The prerecorded message may be “A child is in the car and needs help!” or other appropriate message.

The notification selector would then preferably direct the car's CPU 17 to open the car windows, blow the horn, remotely start the car and turn on the air-conditioner, and make the chosen public address announcement if “local” is enabled. If “remote” is enabled, a dialing device will connect with a cell phone system to make a call to a selected pre-chosen phone number, preferably of the driver's cell phone, to announce the message via techniques well known in the art. The message may be left as a voice mail or text message to a cell phone, an alpha-numeric message to a pager, delivered directly, or as an email to a wireless PDA, wireless to a mobile computer, or via cable or telephone line to a desktop computer. In accordance with the invention, mass notifications to multiple addresses or recipients of emails, text messages, voice messages, or voice pages may be made simultaneously or sequentially to increase the likelihood of successful receipt of the message by a responder who can take action to rescue or relieve the occupant.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

I claim:

1. Remote notification system for an automobile comprising:
a detector in the automobile capable of detecting the presence of an animate occupant, an arming device for activating the system when the car is stopped and the door is opened,
a notification selector connected to the arming device for selecting local or remote announcements, comprising one or more prerecorded alarm messages,
a CPU connected to the notification selector and to the car window, horn, and PA systems,
a dialing apparatus connected to the notification selector,
a transmitter capable of transmitting the notification of the presence of an animate object, and a receiver capable of receiving the transmitted notification,
where the transmitter transmits the message as a voice message to a cell phone.

2. the system of claim 1 where the detector detects the presence by detecting a sound from the occupant.

3. the system of claim 1 where the detector detects the presence by detecting heat from the occupant.

4. the system of claim 1 where the detector detects the presence by detecting heartbeat from the occupant.

5. the system of claim 1 where the detector detects the presence by detecting a motion from the occupant.

6. the system of claim 1 where the detector detects the presence by detecting the presence of an RFID chip in or on the occupant.

7. Remote notification system for an automobile comprising:
a detector in the automobile capable of detecting the presence of an animate object,
an arming device for activating the system when the car is stopped and the door is opened,
a notification selector connected to the arming device for selecting local or remote announcements, comprising one or more prerecorded alarm messages,
a CPU connected to the notification selector and to the car window, horn, and PA systems,
a dialing apparatus connected to the notification selector,
a transmitter capable of transmitting the notification of the presence of an animate object,
and a receiver capable of receiving the transmitted notification,
where the transmitter transmits the message as a text message to a cell phone.

8. the system of claim 7 where the detector detects the presence by detecting a sound from the object.

9. the system of claim 7 where the detector detects the presence by detecting heat from the object.

10. the system of claim 7 where the detector detects the presence by detecting heartbeat from the object.

11. the system of claim 7 where the detector detects the presence by detecting a motion from the object

12. the system of claim 7 where the detector detects the presence by detecting the presence of an RFID chip in or on the occupant.

13. Remote notification system for an automobile comprising:
a detector in the automobile capable of detecting the presence of an animate object,
an arming device for activating the system when the car is stopped and the door is opened,
a notification selector connected to the arming device for selecting local or remote announcements, comprising one or more prerecorded alarm messages,
a CPU connected to the notification selector and to the car window, horn, and PA systems,
a dialing apparatus connected to the notification selector,
a transmitter capable of transmitting the notification of the presence of an animate object, and a receiver capable of receiving the transmitted notification,
where the transmitter transmits the message an announcement over a public address system.

14. the system of claim 13 where the detector detects the presence by detecting a sound from the object.

15. the system of claim 13 where the detector detects the presence by detecting heat from the object.

16. the system of claim 13 where the detector detects the presence by detecting heartbeat from the object.

17. the system of claim 13 where the detector detects the presence by detecting a motion from the object

18. the system of claim 13 where the detector detects the presence by detecting the presence of an RFID chip in or on the occupant.

19. Remote notification system for an automobile comprising
a detector in the automobile capable of detecting the presence of an animate object,
a transmitter capable of transmitting the notification of the presence of an animate object,
a receiver capable of receiving the transmitted notification and a prerecorded message,
where the transmitter transmits the message as email to a PDA.

20. the system of claim 19 where the detector detects the presence by detecting a sound from the object.

21. the system of claim 19 where the detector detects the presence by detecting heat from the object.

22. the system of claim 19 where the detector detects the presence by detecting heartbeat from the object.

23. the system of claim 19 where the detector detects the presence by detecting a motion from the object

24. the system of claim 19 where the detector detects the presence by detecting the presence of an RFID chip in or on the occupant.

25. Remote notification system for an automobile comprising:
a detector in the automobile capable of detecting the presence of an animate object,
an arming device for activating the system when the car is stopped and the door is opened,
a notification selector connected to the arming device for selecting local or remote announcements, comprising one or more prerecorded alarm messages,
a CPU connected to the notification selector and to the car window, horn, and PA systems,
a dialing apparatus connected to the notification selector, and
a transmitter capable of transmitting the notification of the presence of an animate object to an emergency 9-1-1 dispatcher.

26. the system of claim 25 where the detector detects the presence by detecting a sound from the object.

27. the system of claim 25 where the detector detects the presence by detecting heat from the object.

28. the system of claim 25 where the detector detects the presence by detecting heartbeat from the object.

29. the system of claim 25 where the detector detects the presence by detecting a motion from the object

30. the system of claim 25 where the detector detects the presence by detecting the presence of an RFID chip in or on the occupant.

31. Remote notification system for an automobile comprising:
a detector in the automobile capable of detecting the presence of an animate object,
a transmitter capable of transmitting the notification of the presence of an animate object,
a receiver capable of receiving the transmitted notification,
and a prerecorded message
where the presence is signaled by sending a message to the operator and remedied by opening the car windows opening the car windows.

32. the system of claim 31 where the detector detects the presence by detecting a sound from the object.

33. the system of claim 31 where the detector detects the presence by detecting heat from the object.

34. the system of claim 31 where the detector detects the presence by detecting heartbeat from the object.

35. the system of claim 31 where the detector detects the presence by detecting a motion from the object

36. the system of claim 31 where the detector detects the presence by detecting the presence of an RFID chip in or on the occupant.

37. Remote notification system for an automobile comprising:
a detector in the automobile capable of detecting the presence of an animate object,
a transmitter capable of transmitting the notification of the presence of an animate object,
a receiver capable of receiving the transmitted notification, and
a prerecorded message,
where the condition is signaled by turning on the car fan air circulation.

38. the system of claim 37 where the detector detects the presence by detecting a sound from the object.

39. the system of claim 37 where the detector detects the presence by detecting heat from the object.

40. the system of claim 37 where the detector detects the presence by detecting heartbeat from the object.

41. the system of claim 37 where the detector detects the presence by detecting a motion from the object

42. the system of claim 37 where the detector detects the presence by detecting the presence of an RFID chip in or on the occupant.
